(19) United States
(12) Patent Application Publication
(10) Pub. No.: US 2016/0157440 A1
(43) Pub. Date: Jun. 9, 2016

(54) GREENHOUSE HAVING AN AIR MIXING CHAMBER WHICH IS EQUIPPED WITH A HEATING UNIT AT AN AMBIENT AIR INLET

(71) Applicants: VB GROUP B.V., De Lier (NL); LOOIJE TOMATEN HOLDING B.V., Maasdijk (NL)

(72) Inventors: Jochem Vincent Looije, Maasdijk (NL); Antonius G.E.M. Driessen, Gouda (NL)

(21) Appl. No.: 14/906,617

(22) PCT Filed: Jul. 25, 2014
(86) PCT No.: PCT/NL2014/050516

§ 371 Date: Jan. 21, 2016

(30) Foreign Application Priority Data
Jul. 25, 2013 (NL) 2011217

(51) Int. Cl. A01G 9/24

(52) U.S. Cl. CPC A01G 9/246

(57) ABSTRACT

A greenhouse includes housing walls delimiting a growing space for growing plants, an air mixing chamber for conditioning of air, air distribution for distributing conditioned air from the air mixing chamber into the growing space along the plants, a re-circulation air connection connecting the growing space to the air mixing chamber for having used air flow from the growing space back into the air mixing chamber, an ambient air inlet connecting the environment to the air mixing chamber for having ambient air flow from the environment into the air mixing chamber, and a heating unit for heating of air. The heating unit is located at the ambient air inlet for heating ambient air before it gets mixed in the air mixing chamber with used air.

### CROSS-REFERENCE TO RELATED APPLICATIONS

This application is the National Stage of International Application No. PCT/NL2014/050516 filed Jul. 25, 2014, which claims the benefit of Netherlands Application No. NL 2011217, filed Jul. 25, 2013, the contents of which is incorporated by reference herein.

### FIELD OF THE INVENTION

The invention relates to a greenhouse of the type having an air mixing chamber inside which used re-circulation air coming out a growing space inside the greenhouse can be mixed with fresh ambient air, which mixture can then be distributed into the growing space of the greenhouse.

### BACKGROUND OF THE INVENTION

A greenhouse is a structural building of which the roof and mostly also the side walls are constructed such that they are able to allow sunlight to enter into the growing space. For this greenhouses have a glass or plastic roof and frequently also glass or plastic side walls, such that the sunlight may enter the growing space. Greenhouses, in particular glass greenhouses, may be filled with equipment such as screening installations, heating, cooling and artificial lightning, and may be automatically controlled by a computer to maximize potential growth of the plants therein. This is amongst others is done by controlling temperature, levels of light and shade, irrigation, fertilizer application and humidity. Ventilation is one of the most important components in a greenhouse. If there is no proper ventilation, greenhouses and their growing plants can become prone to problems. The main purposes of ventilation are to regulate the temperature and humidity to an optimum level, and to ensure movement of air and thus prevent build-up of plant pathogens that prefer windless conditions. Ventilation also ensures a supply of fresh air for photosynthesis and plant respiration. Heating and ventilation electricity at present are the most considerable costs in the operation of greenhouses, especially in colder climates. The main problem with heating a greenhouse as opposed to a building that has solid opaque walls is the amount of heat lost through the greenhouse roof and side walls.

Such a greenhouse for example is known from WO 2008/002686. The glass greenhouse construction shown herein delimits a growing space for growing plants under conditioned circumstances. At an end side of the greenhouse one or more climate control systems are provided which are each designed to condition air in such a way that it can be suitably distributed over and along the plants by means of ventilators and air distributing tubes. The climate control system comprises an air mixing chamber which here is delimited by means of a partition wall separating it from the growing space. The air mixing chamber at a lower side is equipped with a first vent through which ambient air can enter. At an upper side it is equipped with a second vent through which used re-circulation air can enter. Both vents can be opened or closed by means of louvers which here are formed as slidable shield plates. Between the ventilator and the air distributing tubes a heat exchanger is included, which can be used to heat or cool the air mixture before it flows via the tubes into the growing space. At the first vent a cooling mechanism is included, which can be used to cool and/or to dehumidify ambient air which is pulled into the mixing chamber. The cooling mechanism for example is formed by a pad cooling system.

A disadvantage with this known climate control system is that it is rather expensive to operate because it requires a lot of electricity/fuel. Also the ventilator requires a lot of capacity because the entire mixture needs to be pulled through the heat exchanger. Furthermore it is not always possible to get the mixture of ambient air and used re-circulation air properly conditioned to desired temperatures and humidity levels before it enters the growing space. Also condensation problems may occur when the used re-circulation air has a high humidity level and starts mixing with colder ambient air. On the other hand it may also occur that, for example during the night, when the outside temperature drops, too dry air mixtures are distributed into the growing space along the plants, with negative effects for the plants. This can for example be caused by the fact that in order to keep the air mixture to be distributed into the growing space, warm enough, all or almost all of the air mixture needs to be formed by used re-circulation air. Inflow of cold ambient air would lower the temperature of the air mixture too much for the heat exchanger to be able to heat up the entire mixture again or would be too costly in terms of operating costs for the heat exchanger.

Another example of this type of greenhouse is disclosed in NL-1032779. Here a greenhouse is equipped with an internally located air treatment chamber having a closeable re-circulation air connection and a closeable ambient air inlet. At a lower end of the chamber a ventilator is provided for pulling air into a distributing tube which extends throughout the greenhouse. At the re-circulation air connection a cooling unit is placed which serves the purpose of cooling and/or dehumidifying used air which flows out of the growing space into the treatment chamber. Furthermore a heating unit is provided inside the chamber. The heating unit in a first embodiment is placed just in front of the ventilator at a lower side of the air treatment chamber, and in a second embodiment is placed in a middle part of the air treatment chamber right underneath both the re-circulation air connection and the ambient air inlet.

Owing to the provision of the cooling unit at the re-circulation connection it is now possible to condition the used re-circulation air to lower temperatures and lower level of humidity. It is however substantially more expensive to operate because the cooling and dehumidifying of the used re-circulation air at the location of the re-circulation air connection immediately leads to the heating unit later on having to deliver more effort to heat up the entire air mixture again. Also problems still occur with condensation of water at undesired locations when the use re-circulation air starts mixing with colder ambient air.

### SUMMARY OF THE INVENTION

The present invention aims to at least partly overcome the abovementioned disadvantages or to provide a usable alternative. In particular the present invention aims to provide a multi-functional, user-friendly and economic greenhouse of which the operating costs can be further lowered and with which optimal climate conditions for the plants inside the greenhouse can more easily be maintained even when the environmental or weather conditions strongly differ over time or are more harsh. More in particular it is an aim of the present invention to have air conditioned by using a constructional simple air mixing chamber which has a minimized resistance for the air.

This aim is achieved by means of a greenhouse according to the present invention. This greenhouse comprises housing walls which delimit a growing space for growing plants. An air mixing chamber is provided for conditioning of air, which conditioned air can then be distributed by means of air distribution means from out of the air mixing chamber into the growing space and along the plants. The growing space is connected by means of a re-circulation air connection to the air mixing chamber. Thus used re-circulation air is able to flow from the growing space back into the air mixing chamber. Further the air mixing chamber is connected by means of an ambient air inlet to the environment (open air) outside the greenhouse. Thus fresh ambient air is able to flow from the environment into the air mixing chamber. A heating unit is provided for heating air. According to the inventive thought this heating unit is located at the ambient air inlet. With located at the ambient air inlet it is meant that the heating unit is located at such a position that it is possible to heat ambient air immediately when it gets pulled into the mixing chamber, that is to say before it gets the ability to mix itself in the air mixing chamber with used air. This has the important advantage that the operating costs of the conditioning of air for the greenhouse can substantially be reduced compared to the abovementioned known state of the art solutions. A heating of the entire air mixture including an amount of the relative humid used re-circulation air can be minimized or is no longer necessary. The heating of (part of) the ambient air, before it starts to mix with the used re-circulation air under most circumstances already may suffice. By heating the ambient air before it gets to contact and mix itself with the used re-circulation air, condensation problems at undesired locations can be minimized or do not occur. The relative warm and humid used re-circulation air merely gets into contact with relative warm ambient air. Thus the used re-circulation air does not suffer a cold wave attack from getting in contact with relative cold ambient air. Because of this, moisture inside the used re-circulation air does not start condensing inside the air mixing chamber or growing space. This helps to increase the health of the plants. On the one hand by reducing a pressure of plant diseases, like viruses, fungus, moulds, or the like, which otherwise might start growing at such undesired condensation spots. On the other hand because it gives an operator more freedom to play with the relative amounts of ambient and used air for forming optimal air mixtures which are to be distributed along the plants. Also it is no longer necessary to mix large amounts of used re-circulation air with ambient air in order to have the air mixture stay above its dew point. This dew point is dependent of the humidity level of the air mixture. The higher the humidity level, the more saturated the air already is, and the less it needs to be cooled down to already start condensing. The heating of the ambient air before it starts mixing with the relative warm and humid used re-circulation air advantageously helps to prevent this problem. An expensive sophisticated climate control system is not necessary for this neither is a dehumidifying of the used re-circulation air before it starts mixing with the ambient air.

In practice it has advantageously appeared that savings in energy consumption of more than 10% can be obtained owing to the present invention. This saving was mainly achieved in less electricity being necessary. In particular for large-scale glass greenhouses this saving is an important one which pays off and is truly worthwhile. Furthermore, owing to the invention, less power in air distribution means could be installed. In fact a saving in installed power of in particular ventilators of the air distribution means of close to 50% appeared possible. Also it was noticed in practice that the quality of the plants growing in the inventive greenhouse appeared to have further improved, while at the same time less pesticides could be used.

It is noted that GB 2 018 116 shows a sort of incubator installation for cultivation of young vulnerable plants. It is also referred to as a closed climate cell, which is quite different from a greenhouse. Not only it is much smaller, more importantly such a closed climate cell does not have glass/plastic roof or side walls and is constructed such that no sunlight can enter into the closed climate cell. Instead use is being made of high intensity discharge lamps. Those high intensity discharge lamps produce so much heat that additional precautionary measures are necessary because otherwise excessive heat may adversely affect the temperature of the plants. Too high a temperature is injurious to most plants. Therefore, when too much heat is generated by the lamps, it becomes necessary to condition the air in order to lower the temperature. For this fresh ambient air can be introduced into the cell. This ambient air is deemed to be less moist than the used air it replaces, thus serving to control the humidity within the chamber. In GB 2 018 116 two heat exchangers are provided in series in the incoming stream of ambient air which mainly are used for cooling the ambient air, since as clarified above there is almost always an excess of heat in the closed climate cell. Only when the temperature of the ambient air is below a required minimum, heating will be required. Further it is noted that the entire flow of ambient air needs to pass through both the heat exchangers in series, even when no cooling is desired at all. This requires a lot of power because of the important additional flow resistance those heat exchangers exert on the ambient air flow.

Further it is noted that GB 1 242 500 shows means for supplying ventilation air in rooms with very high requirements in respect of draught-free injection and the supply of large air volumes, in particular in animal stables like for example a broiler house. A greenhouse is also mentioned in this GB 1 242 500 as example where high requirements have to be met on draught-free injection and uniform temperature distribution. According to the invention of GB 1 242 500, use is to be made of two plastic hoses which have different cross-sectional areas and with one hose mounted inside the other hose. For the particular aimed use of this nested plastic hose construction in an animal shed or stable, like a broiler house, it is shown in FIG. 1 of GB 1 242 500 and described in the corresponding part of the figure description that a ventilating apparatus is connected to an opening in one wall of the animal shed or stable. The ventilating apparatus comprises a fan portion and a mixing chamber for mixing return air and outside air in suitable portions prior to the suction into the fan portion. A heating or cooling battery is mounted in the opening. Such an animal shed or stable like a broiler house however is quite different from a greenhouse. It does not have glass/plastic roof or side walls, and problems with humidity control, condensation, dew points and cold wave attack, do not play any role whatsoever for such broiler houses. Also the amounts of air that need to be distributed through the animal shed or stable or way smaller than the amounts of air that need to be distributed through a greenhouse. Furthermore the position of the ventilating apparatus and air distribution device and/or whether it can be a pre-fab wall-mounted unit or needs to be integrated, is not critical, which is in sharp contrast with the demands for a greenhouse.

The ambient air inlet and/or the re-circulation air connection according to the present invention preferably comprise one or more adjustable gates. Those gates may for example be operated by means of one or more servo motors which can be controlled by a control unit like a computer. The adjustable gates can for example be formed by slidable or rotatable plates which are able to open or close the inlet and connection to lesser or greater degrees in dependence of detected conditions of the ambient air and used re-circulation air and/or in dependence of desired conditions for the air mixture to be obtained. Thus the respective flows of ambient air and used air can accurately be regulated.

In a preferred embodiment the heating unit covers at least part of the ambient air inlet and comprises openings for ambient air to flow through, preferably controlled by an adjustable gate. Thus ambient air can be flown along heat exchanging surfaces and can be heated in an efficient manner to a desired temperature, preferably a temperature close to the desired temperature in the growing space.

In a further embodiment the heating unit covers only a first part of the ambient air inlet. Another second part of the ambient air inlet can then advantageously be formed by a substantially free opening for ambient air to flow through unhindered, preferably controlled by an adjustable gate. The free opening offers the possibility to let a part or all of the ambient air flow freely into the mixing chamber without getting heated. This option can advantageously be used when the outside temperature is already high enough within certain desired limits, and for example is already lying close to the desired temperature in the growing space. This option can also be advantageous when the ambient air temperature is relative high, while at the same time a relative high flow of ambient air is desired for forming the air mixture, without this relative high flow of ambient air needing to get too much heated. For example when the outside temperature lies above 10° C. a part of the ambient air flowing into the air mixing chamber, already can get by-passed such that it does not have to flow through the heating unit in order to be able to enter into the mixing chamber. The flow resistance of ambient air flowing through the substantially free opening is lower than the flow resistance of ambient air flowing through the heating unit, in particular at least two times lower. This by-pass option of ambient air which can start flowing partly or wholly around the heating unit part of the ambient air inlet, is particularly advantageous and important because the flow resistance in the heating unit raises squared with air intake speed, whereas the necessary power/capacity of the air distribution means even raises to the third power with air intake speed. Owing to the substantially free opening part of the ambient air inlet with its much lower flow resistance compared to the heating unit, the air intake speed through the entire ambient air inlet can be importantly lowered as soon as the outside temperature gets high enough, resulting in an impressive reduction (of up to the third power) in energy consumption of ventilators of the air distribution means.

In addition thereto or in the alternative, the second part or yet another third part of the ambient air inlet can advantageously be covered by a cooling unit, in particular one which comprises openings for ambient air to flow through, preferably controlled by an adjustable gate. The cooling unit then offers the possibility to let a part or all of the ambient air flow into the mixing chamber while at the same time getting cooled. This option can advantageously be used when the outside temperature is relative high, and for example is already higher than the desired temperature inside the growing space.

In a variant the heating unit can be of a proportional type comprising sections with differing heating capacities, preferably controlled by an adjustable gate. The adjustable gate in front of the heating unit then is able to give free one or more distinctive ones of those sections. This makes it for example possible to have a relative minimal flow of ambient air flow into the mixing chamber while still having this minimal flow heated to a relative high temperature by having it flow along a section of the heating unit with relative high heating capacity. This for example can be advantageous when the ambient air temperature is relative low, while at the same time a relative low amount of highly heated ambient air is desired for forming the air mixture.

In another embodiment at least a part of the re-circulation air connection can be formed by a substantially free opening, preferably controlled by an adjustable gate. The free opening at that location offers the possibility to let at least a part of the used re-circulation air flow freely into the mixing chamber. This option can advantageously be used whenever the used re-circulation air already has conditions within certain agreeable limits, and in particular still is comparable to the desired air temperature and/or humidity level inside the growing space.

In addition or in the alternative a part of the re-circulation air connection can be covered by a dehumidifying and/or cooling unit, preferably controlled by an adjustable gate. This makes it possible to dehumidify and/or cool used re-circulation air before it gets mixed with ambient air in the air mixing chamber. Thus, whenever deemed necessary, the temperature and/or relative humidity in the used re-circulation air can be lowered to a more acceptable level before it gets to mix with the possibly partly or wholly heated flow of ambient air, and thus may help to further decrease condensation problems to occur.

The heating unit can be of a direct or indirect heating type. In a preferred embodiment the heating unit comprises a radiator which uses a heat exchanging medium. This heat exchanging medium can for example be formed by water, oil or the like. Preferably it comprises an antifreeze liquid, like glycol. Thus it is advantageously prevented that the heating unit gets frozen whenever the outside temperature drops below zero. This is particularly important since the heating unit according to the invention is located at the ambient air inlet and thus may well be in direct contact with the open air.

The heating unit can be operated and supplied with energy in all kinds of manners. Advantageously it may be connected to a heat exchanger located underneath or inside the growing space. This may help to further save on operating costs by making use of the relative high temperature occurring inside the growing space for heating up the heat exchanging medium.

The ambient air inlet preferably is positioned near ground level. In this way the heating unit during the day does not block incoming sunlight.

Likewise the air distribution means, including one or more perforated air distribution tubes extending through the growing space, are also preferably positioned near ground level, underneath growing tables or the like on top of which the plants are placed. In this way the air distribution means advantageously do not block the plants from sunlight. It is however also possible for the tubes to be positioned in an upper part of the growing space, for example if the plants are to be grown directly in the ground.

A shield can be positioned in front of the ambient air inlet. This shield can help to prevent wind, particles and rain from getting blown into the mixing chamber. The shield preferably is positioned in a slightly slanted position. The shield can be made out of a sound-damping material, in order to dampen any sounds coming from inside the mixing chamber and/or growing space, like for example caused by a ventilator of the air distributing means. Further it is noted that the shield can also be made out of light-blocking and/or light-absorbing material. Thus a demand can be fulfilled that with artificial lighting of the plants during night time no hindrance occurs for the environment, while at the same time a substantially free opening is realized for a 100% ambient air intake.

The growing space can be provided with a vent for air to escape to the environment in case of overpressure. Such a vent can for example be formed by an air window on top of the greenhouse. Thus the growing space advantageously can be kept at a pressure which is larger than the ambient pressure. This helps to prevent that air, germs, dust particles or the like can flow directly into the growing space without first having to pass the ambient air inlet.

According to the invention the air distribution means, and in particular the ventilators thereof, in particular are designed to distribute at least 20 m³ air per m² ground per hour into the growing space. The greenhouse according to the invention is likely to cover an area of ground space of 30.000-100.000 m². The necessary amounts of air therefore in practice may rise to 100 m³ air per m² ground per hour. The total amounts of air which need to be distributed by the air distribution means for the entire greenhouse are such high that the heating unit part and the free opening part of the air inlet opening are to be integrated directly into one of the walls of the greenhouse, whereas the air mixing chamber gets integrated into the greenhouse design. This is important to be able to distribute the aimed total amounts of air in an economic manner. A use of prefab wall-mounted units then would not be feasible.

Further advantageous embodiments are stated in the detailed description.

The invention also relates to a method for conditioning air for operating a greenhouse.

Besides a control of the greenhouse temperature by heating and/or cooling, the climate inside the growing space is also determined by the relative humidity inside the greenhouse. Under all circumstances a balance must be present between the amount of moisture that is evaporated by the plants, and the amount of moisture that is transported to outside the growing space. Such transportation of moisture in the invention shall take place by feeding a proper mixture of fresh ambient and used re-circulation air into the growing space. This air mixture with a sufficiently low humidity then is well able to take in some moisture. By having some fresh ambient air flow into the greenhouse, excess moist used air then can gets transported to outside the growing space for example via the abovementioned vents. Via those vents an exchange of greenhouse air and ambient air can take place.

However this system of ventilation still may be somewhat dependent of wind direction and wind-force. Therefore according to a further aspect of the present it is aimed to further improve the accuracy and reliability, while at the same time being able to save even more energy.

According to the present invention, the amounts of ambient/used air that need to get drawn into the air mixing chamber and subsequently fed into the growing space can be accurately controlled by means of a suitable steering of the speed and capacity of the air distribution means, preferably in combination with a suitable steering of the adjustable gate of the ambient air inlet and/or of the adjustable gate of the re-circulation air connection. Together those measures make it possible to accurately control and dose the amounts of fresh ambient air flowing into the growing space, and to accurately control and dose the amounts of excess used air that need to leave the growing space.

The present invention aims to further improve this by providing a feed forward control method. In this feed forward control method, a control unit is designed to calculate beforehand, over time, the deemed necessary amounts of fresh ambient air and used re-circulation air that are to be forced to flow as a mixture along the plants inside the growing space. This calculation beforehand is done based upon some key factors, like for example weather forecasts including expected amounts and intensities of sunlight, growing stadia of plants in the growing space including expected amounts of evaporation by those plants in dependence of their growing stadia and weather forecast, and/or differences between desired humidity levels inside the growing space and expected humidity levels in the ambient air. Thus it can be estimated beforehand for all kinds of differing circumstances at which capacity/speed the air distribution means need to be driven and at which positions the gates need to be set such that the greenhouse gets ventilated with the right amounts of air and with the right mixtures of fresh ambient and used re-circulation air.

In a particular embodiment the invention further provides in an indirect accurate measuring method for the determination of the amounts of fresh ambient air that gets to flow through the ambient air inlet into the air mixing chamber and from there into the growing space. For this on the one hand the amounts of air displaced by the air distribution means are determined, while on the other hand the amounts of used re-circulation air flowing through the re-circulation air connection back into the air mixing chamber are determined. Both are determined in dependence of differing degrees of energizing of the air distribution means and in dependence of differing positions of adjustable gates of the ambient air inlet and/or of the re-circulation air connection. Subsequently differences are calculated between the actual determined amounts of air that flow through and get displaced by the air distribution means and the actual determined amount of used air that flow through the re-circulation air connection back into the air mixing chamber. This results in a relation between them and the differing degrees of energizing of the air distribution means and the differing positions of the adjustable gates of the ambient air inlet and/or of the re-circulation air connection. The calculated differences then advantageously can be taken to be substantially equal to amounts of fresh ambient air that get to flow through the ambient air inlet into the air mixing chamber in dependence of said differing degrees of energizing of the air distribution means and in dependence of said differing positions of adjustable gates of the ambient air inlet and/or of the re-circulation air connection.

Thus a feed forward control method is advantageously possible. The amounts of fresh ambient air and used re-circulation air that are to be forced to flow over time as a mixture along the plants inside the growing space, can now truly and easily be calculated beforehand by means of suitable control unit. In correspondence therewith the air distribution means can get energized and the gates can get adjusted over time. This makes it possible to stably and accurately control the capacities of the air distribution means, and in particular the speeds of one or more mechanically operated ventilators thereof. For all kinds of circumstances de necessary capacities for the air distribution means are known up front and can be more easily controlled. The actually measured humidity inside the growing space now only results in a limited correcting effect, owing to which the control of the air distribution means gets greatly stabilized.

In a preferred embodiment the determination of the actual amount of air that gets displaced by the air distribution means can be based upon measurements of pressure sensors that get positioned upstream and downstream of the air distribution means. A suitable signal transformer then can be used to calculate the actual amount.

In another preferred embodiment the determination of the actual amount of used re-circulation air flowing through the re-circulation air connection can be based upon a measurement of an air speed sensor that gets positioned in the re-circulation air connection. A suitable signal transformer then can be used to calculate the actual amount. It is noted that the above described feed forward control unit and method area not only advantageous for the present invention with its heating unit located at the ambient air inlet, but also can advantageously be used in combination with other types of greenhouses in which for example no heating unit is provided at the ambient air inlet, but at another position relative to the air mixing chamber, for example inside the air mixing chamber or even downstream thereof.

### BRIEF DESCRIPTION OF THE DRAWINGS:

The invention shall now be explained in more detail with reference to the accompanying drawings, in which:

FIG. 1 shows a schematic cross-sectional view of a first embodiment of the greenhouse according to the invention with a heating unit at an ambient air inlet;

FIG. 2 shows a second embodiment;

FIG. 2A shows a variant embodiment with a feed forward control option according to a second aspect of the invention;

FIG. 3 shows a third embodiment;

FIG. 4 shows a fourth embodiment;

FIG. 5 shows a fifth embodiment;

FIG. 6 shows a sixth embodiment;

FIG. 7 shows a seventh embodiment; and

FIG. 8 shows an eight embodiment.

### DETAILED DESCRIPTION OF THE INVENTION:

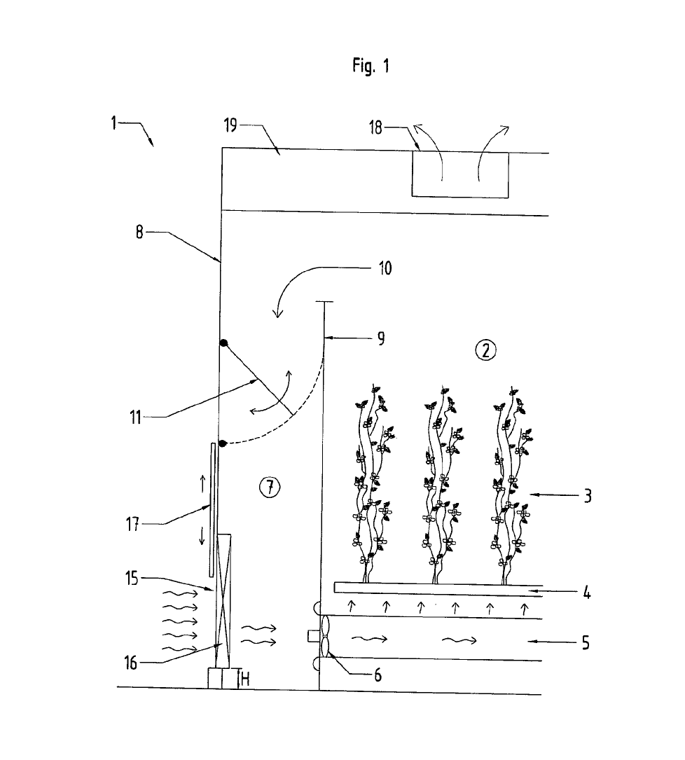

In FIG. 1 the entire greenhouse has been referred to with the reference numeral 1. The greenhouse 1 comprises a growing space 2 inside which a plurality of plants 3 are present. The plants 3 are placed on cultivation gutters 4. Underneath the gutters 4, air distribution tubes 5 are placed which are provided with a large number of outflow openings. A ventilator 6 pulls conditioned air out of an air mixing chamber 7, blows this conditioned air into the tubes 4, via which the conditioned air is suitably distributed through the growing space 2 and along the plants 3.

The air mixing chamber 7 is provided at a front end of the greenhouse 1 and is delimited by outer walls 8 of the greenhouse 1 and by a so-called plenum wall 9 which is placed inside the greenhouse 1 in between the growing space 2 and the chamber 7.

At its upper side the chamber 7 is provided with a re-circulation air connection 10, which here is formed by a free opening. An adjustable gate 11 is provided underneath the connection 10. The gate 11 here is formed by a plate which can be hinged between open and closed positions and any position in between. In FIG. 1 an intermediate position is shown. Thus it can be set how big a flow of used air is allowed to flow out of the growing space 2 and re-circulate back into the chamber 7.

At its lower side at a distance h above ground level the chamber 7 is provided with an ambient air inlet 15. The distance h preferably is less than 0.5 meter. The inlet 15 here is covered in its entirety by a heating unit 16. The heating unit 16 is formed by a radiator provided with openings for the ambient air to flow through. When activated the unit 16 is supplied with pre-heated heat exchanging medium, preferably a liquid comprising an antifreeze like glycol. An adjustable gate 17 is provided in front of the inlet 14. The gate 17 here is formed by a plate which can be shifted between open and closed positions and any position in between. In FIG. 1 an intermediate position is shown. Thus it can be set how big a flow of fresh ambient air is allowed to flow out of the open air along the heating unit 16 and into the chamber 7. The temperature and humidity of the ambient air strongly differs in dependence of what kind of weather it is outside, whether it is day or night, what kind of season it is, etc. This can be detected, sent to a control unit which then is able to adjust the gates 11 and 17 in order to determine a proper ration between used air and heated ambient air.

Inside the chamber 7 the flows of mostly warm and humid used air and heated ambient air get to mix with each other. This mixture is then blown into the tubes 5.

With this the heating unit 16 is operated such that it heats the ambient air flowing there along up to a temperature close to the desired air temperature inside the growing space 2. Presumably the temperature of the heated ambient air which enters the chamber 7 then also lies close to the temperature of the humid used air. This prevents condensation of water droplets out of the used air inside the chamber 7. Also it makes it possible to have the ventilator 6 to run at a relative low speed/capacity, because it is no longer necessary to pull the entire air mixture including the used air fraction through some kind of heat exchanger. A large part of the air mixture can be pulled substantially unhindered towards the ventilator 6 and from there substantially unhindered into the tubes 5. Depending on the ratio between used air and ambient air, savings of more than 50% in operating costs of the ventilator can thus be obtained.

The heating unit 16 here is of a proportional type with sections of increasing heating capacity from its top to its lower side. Thus when the gate 17 is proportionally opened in order to let only a limited flow of ambient air flow into the chamber 7, this limited flow can more easily be heated to a relative high temperature by having it flow along those sections of the heating unit which have high heating capacities.

The ventilator 6 preferably is driven at such a speed that a pressure of the air inside the growing space 2 gets to be somewhat higher than the ambient air pressure. An amount of air is allowed to flow out of the greenhouse via an air window 18 provided in an upper deck 19 of the greenhouse 1.

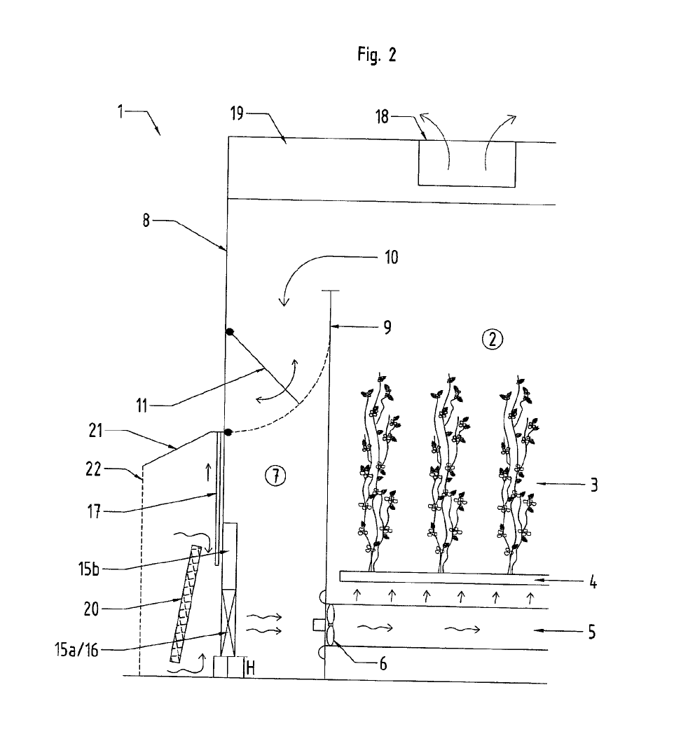

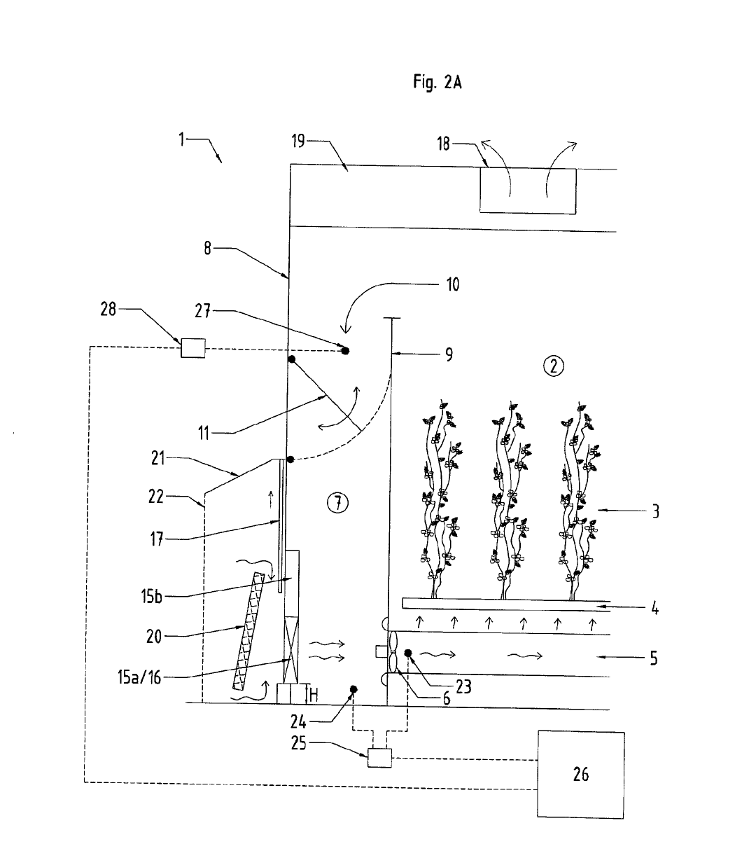

In FIG. 2-8 variants of the FIG. 1 embodiment are shown in which similar parts have been given the same reference numerals. Only those parts which differ shall be briefly explained below.

In FIG. 2 the inlet 15 comprises a first lower part 15a which is covered by the heating unit 16, and a second upper part 15b which is formed by a free inflow opening. The gate 17 can now be shifted to less than half open position in which it merely allows ambient air to flow through the heating unit 16 and thus all the ambient air entering the chamber 7 has gotten heated. The gate 17 can also be shifted to more than half open positions in which it not only allows ambient air to flow through the heating unit 16 in the lower part 15a but also allows some ambient air to flow freely and unheated through the free opening in the upper part 15b. Thus this two part inlet 15 gives more freedom and options to control and condition the incoming ambient air and thus more freedom and options to condition the air mixture.

In FIG. 2 it can also be seen that in front of the inlet 15 a shield 20 is placed. The shield 20 is made out of a light-absorbing and sound-absorbing material. Thus it can be prevented that during night times light can escape from out of the greenhouse 1 to the environment via the inlet 15. Also it can thus be achieved that any noises from out of the greenhouse 1 get dampened when leaving via the inlet 15. The shield 20 is positioned such that ambient air can flow from above and underneath towards the inlet 15. Together with a small roofing 21, the slanted position of the shield 20 helps to prevent that rain and wind can enter the inlet 15. Around the inlet 15 and shield 20, an insect netting 22 is provided. Between the insect netting 22 and the shield 20 a space is left free which makes it possible for a person to gain access there between, whenever this is desired, for example for a cleaning operation.

In FIG. 2A a pressure sensor 23 is positioned inside the tube 5 downstream of and at a short distance behind the ventilator 6, that is to say preferably at a position before air may start to flow out of the tube 5 via one of its outflow openings. Furthermore a pressure sensor 24 is positioned inside the air mixing chamber 7 upstream of and at a short distance in front of the ventilator, that is to say preferably at a position where the ambient air and the used re-circulation air have already been able to mix somewhat with each other. A first signal transformer 25 is connected to the pressure sensors 23 and 24 for determining the actual delivered capacity at a certain moment in time of the ventilator 6. The first signal transformer 25 then sends this determined capacity to a climate control computer 26.

An air speed sensor 27 is positioned in an upper part of the re-circulation air connection 10, that is to say at a position before the used re-circulation air can get mixed with fresh ambient air inside the air mixing chamber 7. A second signal transformer 28 is connected to the speed sensor 27 for determining the actual amount of used re-circulation air at a certain moment in time flowing back towards the air mixing chamber 7. The second signal transformer 28 then sends this determined amount to the climate control computer 26.

The amount of fresh ambient air flowing into the air mixing chamber 7 is now determined by the difference between the capacity of air delivered by the ventilator 6 into the tube 5 and the amount of used re-circulation air flowing back into the air mixing chamber 7. In this manner an accurate control is possible of the amount of fresh ambient air flowing into the greenhouse 1. This can be both used during operation as well as for a feed forward control steering of the ventilation of the greenhouse 1. In such a feed forward method the ventilator 6 gets driven at such a speed and the gates 17 and 11 get opened/closed in such a manner by the computer 26 that exactly the right mixture of fresh and used air get mixed with each other and distributed over the plants 3 in the growing space 2.

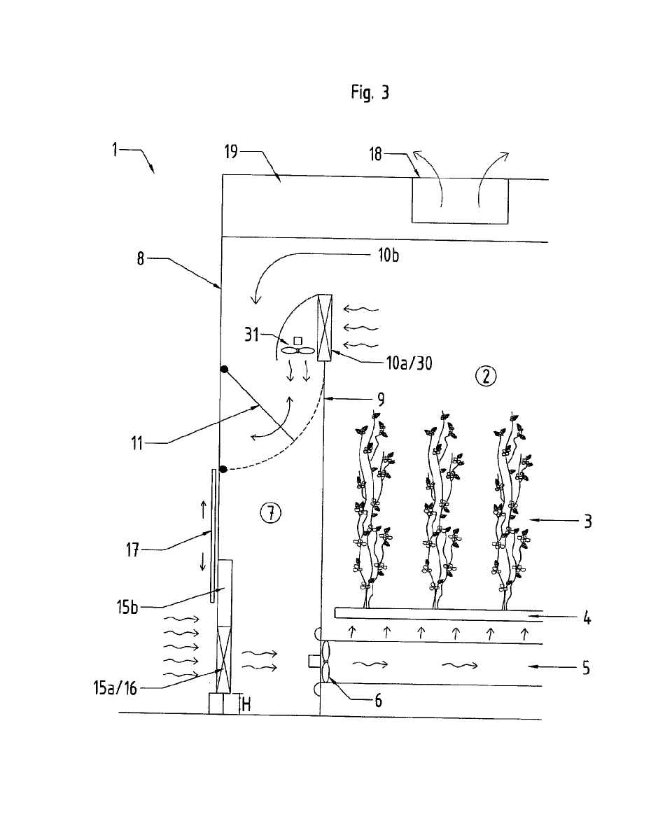

In FIG. 3 it is not only the inlet 15 which has been made two part, but also the re-circulation air connection 10. Here the connection 10 comprises a first lower part 10a which is covered by a cooling/dehumidifying unit 30, and a second upper part 10b which is formed by a free inflow opening. The cooling/dehumidifying unit 30 is equipped with a ventilator 31. Activation of this ventilator 31 shall have the effect that a flow of used air gets drawn through the cooling/dehumidifying unit 30. This fraction then shall get dehumidified by means of direct cooling. Thus this two-part connection 10a, b gives more freedom and options to control and condition the incoming used air and thus more freedom and options to condition the air mixture.

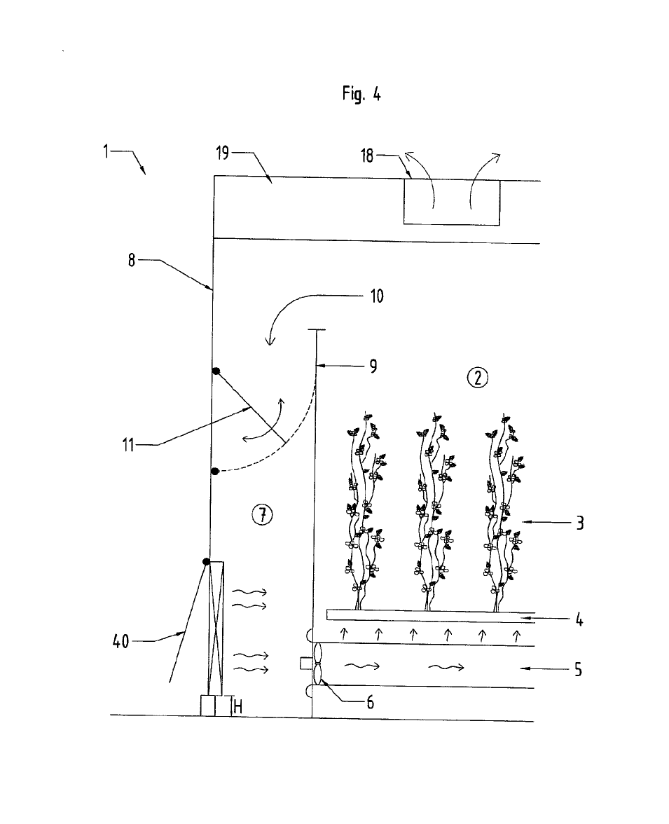

In FIG. 4 the embodiment of FIG. 1 is shown but then with a uniform heating unit 16 and a rotatable plate 40 as gate. The gate can now only be rotated between an open and closed position.

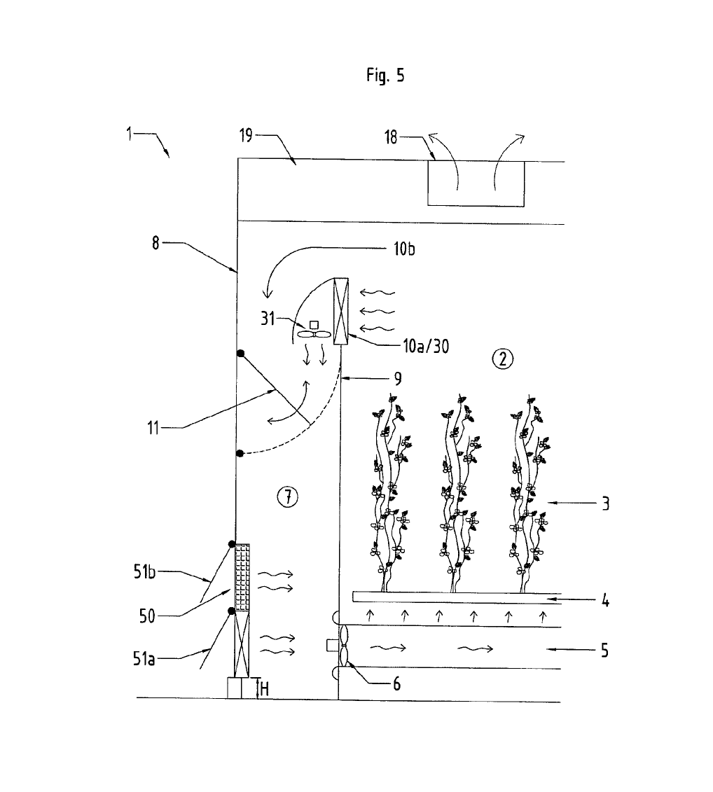

In FIG. 5 the inlet 15 is still made two part, but this time with a cooling unit 50 covering the upper part 15b. The cooling unit 50 here is formed by a so-called padwall (a sort of moistened wall through and along which relative dry ambient air can be drawn into the chamber 7) which makes an adiabatic cooling step possible.

The heating unit 16 and the cooling unit 50 here are each provided with their own adjustable gate 51a and 51b. Those gates 51a, b are formed by rotatable plates and can be operated independently of each other.

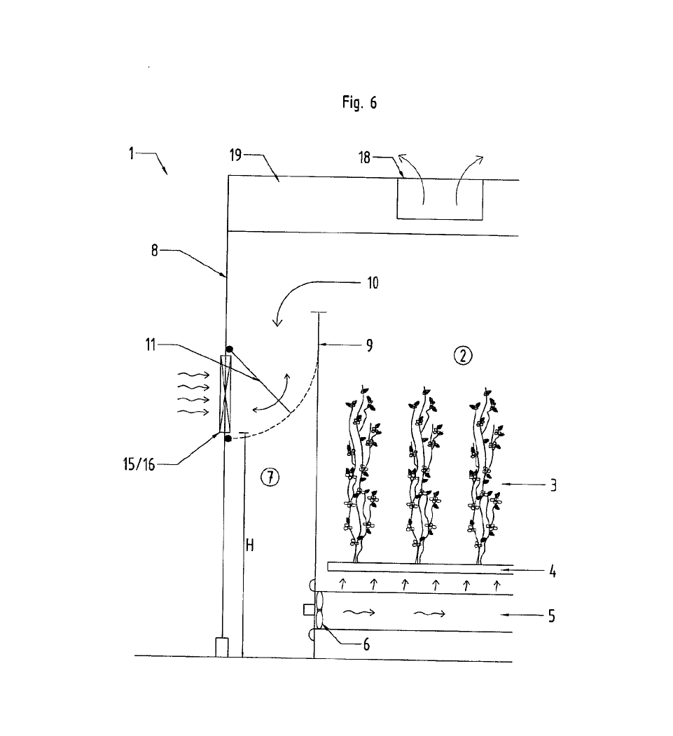

In FIG. 6 the inlet 15 and heating unit 16 are provided at a higher position at a distance H above ground level, namely directly sideways of the rotatable plate of the gate 11. This makes it possible to use a common single gate 11 for at the same time opening the inlet 15 and closing the connection 10 or vice versa.

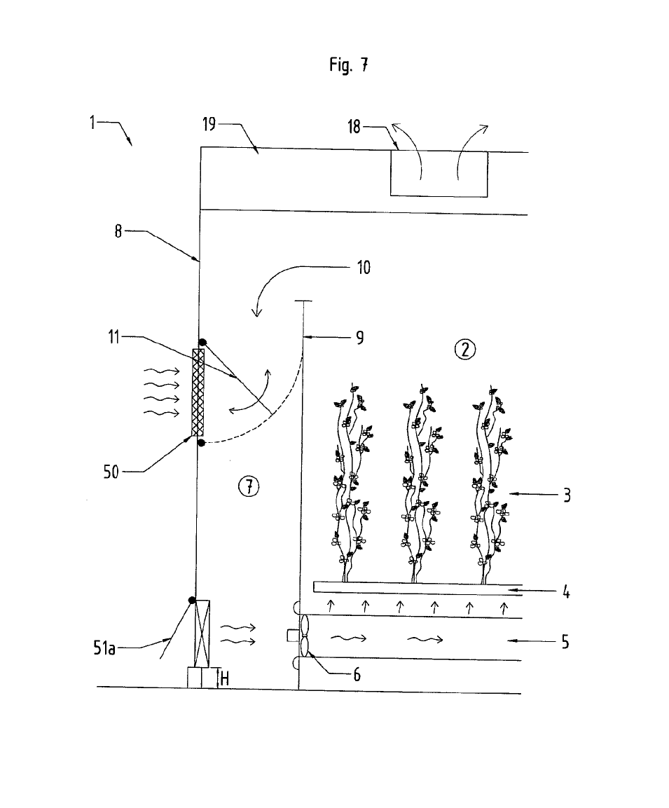

In FIG. 7 the inlet 15 comprises two distinctive parts lying at a distance of each other: a lower part 15a at a distance h above ground level, and an upper part 15b at a distance H above ground level. The lower part 15a is covered by the heating unit 16. The upper part 15b is covered by the cooling unit 50. The heating unit 16 can be opened or closed by the gate 51a. The cooling unit 50 can be opened or closed by the gate 11. Instead of the cooling unit 50 the upper part 15b can also be provided with a free opening.

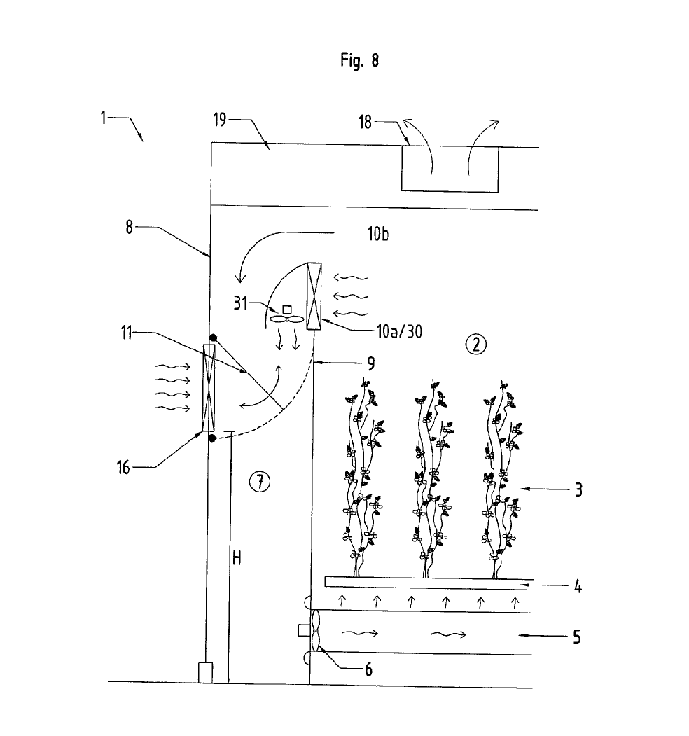

Between the various embodiments of FIG. 1-7 various combinations can be made. For example FIG. 8 shows an embodiment which is a combination of the highly placed inlet 15/heating unit 16 and commonly used gate 11 of FIG. 6, together with the cooling/dehumidifying unit 30 in the lower connection part 10a and the free opening in the upper connection part 10b.

Besides the embodiments shown numerous variants are possible. For example the dimensions and shapes of the various components can be different. Instead of the two-part inlet with the heating unit combined with either the free opening either the cooling unit, it is also possible to use a three-part inlet in which all three options are available. Instead of tubes other kinds of air distributing means can be used. The ventilator does not have to be provided at the entrance of the tubes but can also be provided at another location and/or an extra ventilator can be provided, for example inside the growing space. Instead of shiftable or rotatable plates other kinds of gates can be used, like some kind of Venetian blind.

Thus the invention provides a cost-saving, environmental-friendly climate control for a greenhouse which offers the user a lot of options to have the air conditioned without this costing too much energy and without this leading to condensation problems.
This listing of claims will replace all prior versions and listings of claims in the subject application, and please amend the claims as follows:

1. A greenhouse, comprising:
housing walls delimiting a growing space for growing plants;
an air mixing chamber for conditioning of air;
air distribution means for distributing conditioned air from the air mixing chamber into the growing space along the plants;
a re-circulation air connection connecting the growing space to the air mixing chamber for having used air flow from the growing space back into the air mixing chamber;
an ambient air inlet connecting the environment to the air mixing chamber for having ambient air flow from the environment into the air mixing chamber; and
a heating unit for heating of air;
wherein the heating unit is located at the ambient air inlet for heating ambient air before it gets mixed in the air mixing chamber with used air.

2. The greenhouse according to claim 1, wherein the heating unit covers at least part of the ambient air inlet and comprises openings for ambient air to flow through.

3. The greenhouse according to claim 2, wherein the heating unit covers only a part of the ambient air inlet, whereas another part of the ambient air inlet is formed by a substantially free opening for ambient air to flow through and/or is covered by a cooling unit which comprises openings for ambient air to flow through.

4. The greenhouse according to claim 1, wherein the heating unit is of a proportional type comprising sections with differing heating capacities.

5. The greenhouse according to claim 1, wherein a part of the re-circulation air connection is formed by a substantially free opening.

6. The greenhouse according to claim 1, wherein a dehumidifying and/or cooling unit is located at the re-circulation air connection for dehumidifying and/or cooling used air before it gets mixed with ambient air in the air mixing chamber.

7. The greenhouse according to claim 1, wherein the heating unit comprises a radiator, which radiator uses an antifreeze liquid as heat exchanging medium.

8. The greenhouse according to claim 1, wherein the heating unit connects to a heat exchanger located underneath or inside the growing space.

9. The greenhouse according to claim 1, wherein the ambient air inlet is positioned near ground level.

10. The greenhouse according to claim 1 one of the preceding claims, wherein a shield is positioned in front of the ambient air inlet.

11. The greenhouse according to claim 10, wherein the shield is made out of a sound-damping, light-blocking and/or light-absorbing material.

12. The greenhouse according to claim 1, wherein the ambient air inlet and/or the re-circulation air connection comprise one or more adjustable gates.

13. The greenhouse according to claim 1, wherein the growing space is provided with a vent for air to escape to the environment in case of overpressure.

14. A method for conditioning air for operating a greenhouse according to claim 1 comprising the steps of:
having ambient air flow into the air mixing chamber;
having used air flow into the air mixing chamber; and
having the ambient air and used air get mixed inside the air mixing chamber,
wherein at least part of the ambient air is heated before it gets mixed with the used air inside the air mixing chamber.

15. The method according to claim 14, wherein conditions of the ambient air and used air are detected, in dependence of which adjustable gates for the ambient air and used air are regulated for having ambient air flow through its adjusted gate into a mixing chamber while at the same time getting heated, and for having used air flow through its adjusted gate into the same mixing chamber, to there have it mixed with the heated ambient air, and then have this mixture distributed into the growing space and along the plants.

16. The method according to claim 14, wherein amounts of fresh ambient air and used re-circulation air that are to be forced to flow as a mixture along the plants inside the growing space, are calculated beforehand, over time, wherein this calculation beforehand is performed based upon weather forecasts including expected amounts and intensities of sunlight, and/or growing stadia of plants in the growing space including expected amounts of evaporation by those plants in dependence of their growing stadia and weather forecast, and/or differences between desired humidity levels inside the growing space and expected humidity levels in the ambient air.

17. The method according to claim 15, further comprising the steps of:
determining actual amounts of air that flow through and get displaced by the air distribution means in dependence of differing degrees of energizing of the air distribution means and in dependence of differing positions of adjustable gates of the ambient air inlet and/or of the re-circulation air connection;
determining actual amounts of used air that flow through the re-circulation air connection back into the air mixing chamber in dependence of said differing degrees of energizing of the air distribution means and in dependence of said differing positions of adjustable gates of the ambient air inlet and/or of the re-circulation air connection; and
calculating differences between the actual determined amounts of air that flow through and get displaced by the air distribution means and the actual determined amount of used air that flow through the re-circulation air connection back into the air mixing chamber in dependence of said differing degrees of energizing of the air distribution means and in dependence of said differing positions of adjustable gates of the ambient air inlet and/or of the re-circulation air connection;
wherein the calculated differences are taken to be equal to amounts of fresh ambient air that get to flow through the ambient air inlet into the air mixing chamber in dependence of said differing degrees of energizing of the air distribution means and in dependence of said differing positions of adjustable gates of the ambient air inlet and/or of the re-circulation air connection.

18. The method according to claim 16, wherein based upon the calculation beforehand, the amounts of fresh ambient air and used re-circulation air that are to be forced to flow as a mixture along the plants inside the growing space, are calculated beforehand, over time, and wherein in correspondence therewith the air distribution means get energized and the gates get adjusted over time.

19. The method according to claim 17, wherein the determination of the actual amount of air that gets displaced by the air distribution means is based upon measurements of pressure sensors positioned upstream and downstream of the air distribution means.

20. The method according to claim 17, wherein the determination of the actual amount of used air flowing through the re-circulation air connection is based upon a measurement of an air speed sensor positioned in the re-circulation air connection.
